(19) United States
(12) Patent Application Publication
(10) Pub. No.: US 2011/0028528 A1
(43) Pub. Date: Feb. 3, 2011

(54) PESTICIDAL AQUEOUS SUSPENSION COMPOSITION

(75) Inventors: Yoshiaki Ishihara, Shiga (JP); Takeshi Shindo, Shiga (JP)

Correspondence Address: SUGHRUE-265550, 2100 PENNSYLVANIA AVE. NW, WASHINGTON, DC, 20037-3213, US

(73) Assignee: ISHIHARA SANGYO KAISHA, LTD., Osaka (JP)

(21) Appl. No.: 12/934,860

(22) PCT Filed: Mar. 31, 2009
(86) PCT No.: PCT/JP2009/057038

§ 371 Date: Sep. 27, 2010

(30) Foreign Application Priority Data
Mar. 31, 2008 (JP) 2008-090141

(51) Int. Cl. A01N 43/50; A01P 3/00

(52) U.S. Cl. 514/398

(57) ABSTRACT

When an organosilicone surface active agent is added to a pesticidal aqueous suspension composition containing an active ingredient compound of a sparingly water-soluble pesticide for the purpose of attaining activity enhancement and formulation, the following problems arise: such that (1) the viscosity of the composition increases; (2) a large amount of foams due to the organosilicone surface active agent tends to generate at the time of preparation of a spray solution; and the like. Thus, measuring the composition and preparation of a spray solution were difficult. The present invention provides a pesticidal aqueous suspension composition including (a) an active ingredient compound of a sparingly water-soluble pesticide, (b) an organosilicone surface active agent, (c) a viscosity-reducing agent, (d) an antifoaming agent, (e) a pH adjustor and (f) a dispersant, which is suppressed in increasing in the viscosity, is easy to measure, hardly generates foams at the time of dilution with water and is easy to prepare a spray solution.

### TECHNICAL FIELD

The present invention relates to technology for manufacturing pesticides, more specifically, the present invention relates to a pesticidal aqueous suspension composition comprising a sparingly water-soluble pesticide as an active ingredient compound.

### BACKGROUND ART

Patent Document 1 discloses a composition for controlling harmful bioorganisms with enhanced activity, comprising an imidazole compound including cyazofamid as an active ingredient (a) and, a silicone surface active agent as an activity-enhancing ingredient (c). Also, it discloses that this composition can be blended with various adjuvants, such as an antifoaming agent, a stabilizer, a dispersant and a thickener, and then formulated into various forms. Furthermore, it discloses that an aqueous suspension formulation of this composition can be applied to harmful bioorganisms as is the case of an aqueous dispersion thereof. However, Patent Document 1 does not disclose use of a viscosity-reducing agent as various adjuvants.

Also, Patent Document 1 exemplifies organosilicone surface active agents, such as polyalkylene oxide-modified polymethylsiloxane nonionic surface active agents, as the silicone surface active agent. However, Patent Document 1 does not disclose a generation of a large amount of foams due to the silicone surface active agent in the composition and a controlling method therefor.

Patent Document 2 discloses a low-foaming aqueous formulation which is used for crop protection. This formulation is characterized by a combination of a water-soluble pesticide and a silicone antifoaming agent. However, Patent Document 2 does not disclose a combination of a sparingly water-soluble pesticidal active ingredient and a silicone antifoaming agent.

### Patent Document 1: WO 98/48628

### Patent Document 2: WO 2005/117580

### DISCLOSURE OF THE INVENTION

### Technical Problem

When an organosilicone surface active agent is added to a pesticidal aqueous suspension composition containing an active ingredient compound of a sparingly water-soluble pesticide for the purpose of attaining activity enhancement and formulation, the following problems arise: such that (1) the viscosity of the composition increases; (2) a large amount of foams due to the organosilicone surface active agent tends to generate at the time of preparation of a spray solution; and the like. Therefore, it is difficult to measure the composition and prepare the spray solution.

### Technical Solution

As a result of extensive and intensive investigations in order to solve the foregoing problems, the present inventors have found that that use of a viscosity-reducing agent together with an antifoaming agent can provide a stable composition which is suppressed in increasing in the viscosity of a composition and generating foams at the time of dilution with water as compared with known compositions and the composition can be easily sprayed onto crops, and have completed the present invention.

Namely, the invention relates to a pesticidal aqueous suspension composition comprising (a) an active ingredient compound of a sparingly water-soluble pesticide, (b) an organosilicone surface active agent, (c) a viscosity-reducing agent, (d) an antifoaming agent, (e) a pH adjustor and (1) a dispersant; to a method for reducing the viscosity of a pesticidal aqueous suspension composition comprising (a) an active ingredient compound of a sparingly water-soluble pesticide, (b) an organosilicone surface active agent, (d) an antifoaming agent, (e) a pH adjustor and (f) a dispersant by using (c) a viscosity-reducing agent; and to a method for reducing the foaming property at the time of dilution with water of a pesticidal aqueous suspension composition comprising (a) an active ingredient compound of a sparingly water-soluble pesticide, (b) an organosilicone surface active agent, (c) a viscosity-reducing agent, (e) a pH adjustor and (f) a dispersant by using (d) an antifoaming agent.

### ADVANTAGEOUS EFFECTS

The present invention provides a pesticidal aqueous suspension composition which is suppressed in increasing in the viscosity, is easy to measure, hardly generates foams at the time of dilution with water and is easy to prepare a spray solution.

### BEST MODE FOR CARRYING OUT THE INVENTION

With respect to (a) the active ingredient compound of a sparingly water-soluble pesticide in the pesticidal aqueous suspension composition of the present invention, examples of an active ingredient of a fungicide (common names; including those under application, or test codes of the Japan Plant Protection Association) include an imidazole compound, such as benomyl, thiophanate-methyl, carbendazim, thiabendazole, fuberiazole, and cyazofamid; a pyridinamine compound, such as fluazinam; a phenyl carbamate compound, such as diethofencarb; a dicarboxylmide compound, such as procymidone, iprodione, and vinclozolin; an azole compound, such as diniconazole, epoxiconazole, tebuconazole, difenoconazole, cyproconazole, flusilazole, triadimefon, and probenazole; an acylalanine compound, such as metalaxyl; a carboxyamide compound, such as mepronil, and flutolanil; an amide compound, such as diclocymet; an anilinopyrimidine compound, such as mepanipyrim, pyrimethanil, and cyprodinil; a cyanopyrrole compound, such as fludioxonil, and fenpiclonil; an antibiotic, such as polyoxins; a strobilurin compound, such as azoxystrobin, kresoxim-methyl, and metominofen; an organic chlorine compound, such as fthalide, and chlorothalonil; a dithiocarbamate compound, such as mancozeb, and thiram; an N-halogenothioalkyl compound, such as captan, and folpet; an inorganic copper, such as oxine copper, and a basic copper chloride; a cinnamic acid compound, such as dimethomorph, and flumorph; and an oxazolidinone compound, such as famoxadone; amisulbrom; and the like. Among these, cyazofamid, fluazinam and amisulbrom are especially preferable and cyazofamid is the most preferable in view of revealing the performance of the composition of the present invention.

Also, (a) the active ingredient compound of a sparingly water-soluble pesticide in the pesticidal aqueous suspension composition of the present invention is not limited to the fungicide but also includes an insecticide and a herbicide. Examples of an active ingredient of the insecticide include dimethylvinphos, acephate, salithion, bendiocarb, pirimicarb, methomyl, oxamyl, thiodicarb, bensultap, thiocyclam, diflubenzuron, teflubenzuron, chlorfluazuron, buprofezin, hexythiazox, nitenpyram, clothianidin, clofentezine, pyridaben, and the like. Examples of an active ingredient of the herbicide include simetryn, daimuron, propanil, mefenacet, fentrazamide, etobenzanid, swep, oxaziclomefone, oxadiazon, pyrazolate, prodiamine, cafenstrole, pentoxazone, clomeprop, pyriftalid, benzobicyclone, bromobutide, and the like.

Examples of (b) the organosilicone surface active agent in the pesticidal aqueous suspension composition of the present invention include polyalkylene-modified polymethylsiloxane nonionic surface active agents, such as Makupika (trade name, manufactured by Ishihara Sangyo Kaisha, Ltd.), KF-644 (trade name, manufactured by Shin-Etsu Chemical Co., Ltd.), SILWET L-77 (trade name, manufactured by Momentive Performance Materials), SILWET 408 (trade name, manufactured by Momentive Performance Materials), SLIPPA (trade name, manufactured by INTERAGRO); and the like. When the organosilicone surface active agent is used, spreading properties of a spray solution on foliages can be enhanced.

When the above (b) organosilicone surface active agent is added to the pesticidal aqueous suspension composition, the viscosity of the composition increases depending upon its blend weight ratio, thereby resulting in a hindrance in the handling, such as measuring at the time of spraying. In order to prevent such a problem (c) the viscosity-reducing agent is used in the pesticidal aqueous suspension composition of the present invention. Examples of (c) the viscosity-reducing agent include dihydric alcohol and a polyoxyethylene styrylphenyl ether anionic surface active agent. Examples of the dihydric alcohol include alkylene glycol, such as ethylene glycol and propylene glycol. Among these, propylene glycol is preferably used. Furthermore, the dihydric alcohol also has an effect as an antifreezing agent. The dihydric alcohol is used in an amount of from 2 to 50%, and preferably from 5 to 30%, in terms of % by weight in the composition.

Also, examples of the polyoxyethylene styrylphenyl ether anionic surface active agent include a salt of polyoxyethylene styrylphenyl ether phosphoric acid ester, such as a potassium salt of polyoxyethylene tristyrylphenyl ether phosphoric acid ester and a triethanolamine salt of polyoxyethylene tristyrylphenyl ether phosphoric acid ester; a salt of polyoxyethylene styrylphenyl ether sulfuric acid ester, such as a sodium salt of polyoxyethylene tristyrylphenyl ether sulfuric acid ester and a sodium salt of polyoxyethylene distyrylphenyl ether sulfuric acid ester; an ammonium salt of polyoxyethylene styrylphenyl ether sulfuric acid ester, such as an ammonium salt of polyoxyethylene tristyrylphenyl ether sulfuric acid ester and an ammonium salt of polyoxyethylene distyrylphenyl ether sulfuric acid ester; and the like. Among these, a salt of polyoxyethylene styrylphenyl ether phosphoric acid ester is preferable, and above all, a potassium salt of polyoxyethylene tristyrylphenyl etherphosphoric acid ester is more preferably used. The polyoxyethylene styrylphenyl ether anionic surface active agent also has an effect as a dispersant. The polyoxyethylene styrylphenyl ether anionic surface active agent is used in an amount of from 0.5 to 10%, and preferably from 2 to 6%, in terms of % by weight in the composition.

When the pesticidal aqueous suspension composition of the present invention is diluted with water, a large amount of foams may be generated due to (b) the organosilicone surface active agent occurs, thereby resulting in a hindrance in the preparation of a spray solution. In order to solve such a problem, it is preferable that (d) the antifoaming agent is added to the composition so that the composition comes to be suppressed in generating foams. Examples of (d) the antifoaming agent include silicone antifoaming agents containing, as an active ingredient, polydimethylsiloxane, such as Rhodorsil Antifoam (registered trademark) 416 (trade name, manufactured by Rhodia Nicca Ltd.), Rhodorsil Antifoam (registered trademark) 481 (trade name, manufactured by Rhodia Nicca Ltd.), Rhodorsil Antifoam (registered trademark) 432 (trade name, manufactured by Rhodia Nicca Ltd.), KM 72 (trade name, manufactured by Shin-Etsu Chemical Co., Ltd.), KM 75 (trade name, manufactured by Shin-Etsu Chemical Co., Ltd.), Anti-mousse (trade name, registered trademark; BELCHIM CROP PROTECTION), and the like. The silicone antifoaming agent as referred to herein includes a silica-containing antifoaming agent. The antifoaming agent is used in an amount of from 0.3 to 10, and preferably from 1 to 8, in terms of a weight ratio relative to the formulation.

Examples of (e) the pH adjustor in the pesticidal aqueous suspension composition of the present invention include a buffer, such as a phosphate buffer, Clark-Lubs buffer, an imidazole-hydrochloric acid buffer, a veronal buffer, Britton-Robinson buffer, and Carmody buffer; acid, such as inorganic acid and organic acid; a salt, such as an alkali metal salt of inorganic acid or organic acid, an alkaline earth metal salt of inorganic acid or organic acid and an ammonium salt of inorganic acid or organic acid; and a base, such as a hydroxide of an alkaline metal or an alkaline earth metal. With respect to (b) the organosilicone surface active agent in the composition, its stability is maintained only in a neutral region, and therefore, the pH in the composition is adjusted within the range of from 6 to 8 with (e) the pH adjustor.

Examples of (f) the dispersant which can be used in the pesticidal aqueous suspension composition of the present invention include an anionic surface active agent, such as a naphthalenesulfate, a salt of a naphthalene sulfonic acid-formaldehyde condensate, an alkylnaphthalenesulfate, a salt of an alkylnaphthalenesulfonic acid-formaldehyde condensate, phenolsulfate, a salt of a phenolsulfonic acid-formaldehyde condensate, ligninsulfate, polycarboxylate, a salt of polyoxyethylene alkyl ether sulfuric acid ester, polyoxyethylene alkylaryl ether sulfate, polyoxyethylene alkyl ether phosphate and a salt of polyoxyethylene alkylaryl ether phosphoric acid ester; a nonionic surface active agent, such as an oxyalkylene block polymer, polyoxyethylene alkyl ether, polyoxyethylene alkylaryl ether, polyoxyethylene styrylaryl ether, polyoxyethylene glycol alkyl ether, polyoxyethylene hydrogenated castor oil, polyoxyethylene castor oil; and the like.

In the pesticidal aqueous suspension composition of the present invention, an appropriate blend ratio of (a) the active ingredient compound of a sparingly water-soluble pesticide to (b) the organosilicone surface active agent is usually from 1:5,000 to 100:1, preferably from 0.05:99.95 to 90:10, and more preferably from 0.2:99.8 to 80:20, by weight.

If necessary, in addition to the respective components (a) to (f), an activity-enhancing component can be added to the pesticidal aqueous suspension composition of the present invention. In that case, more excellent effects as a pesticide can be expected. Examples of the activity-enhancing component which can be used include ethoxylated aliphatic amines, such as Frigate (trade name, manufactured by ISK Biosciences Europe S. A.), Genamin T-150 (trade name, manufactured by Clariant), Genamin T-200 (trade name, manufactured by Clariant), Sorpol 7553 (trade name, manufactured by Toho Chemical Industry Co., Ltd.), Sorpol 7409 (trade name, manufactured by Toho Chemical Industry Co., Ltd.), New Kalgen D-3615T (trade name, manufactured by Takemoto Oil and Fat Co., Ltd.), Ethomeen T-25 (trade name), Sorpol 7721 (trade name, manufactured by Toho Chemical Industry Co., Ltd.), New Kalgen D-3605 (trade name, manufactured by Takemoto Oil and Fat Co., Ltd.), Sorpol 7376 (trade name, manufactured by Toho Chemical Industry Co., Ltd.), New Kalgen D-3110 (trade name, manufactured by Takemoto Oil and Fat Co., Ltd.), and Ethomeen C-12 (trade name); polyoxyethylene alkyl ethers, such as ATLOX MBA 11/8 (trade name, manufactured by Uniqema), Synperonic 91/6 (trade name, manufactured by Uniqema), Noigen TDS-70 (trade name, manufactured by Dai-ichi Kogyo Seiyaku Co., Ltd.); alkylsulfosuccinic acid salts, such as New Kalgen EP-70G (trade name, manufactured by Takemoto Oil and Fat Co., Ltd.), AGNIQUE EHS70WE (manufactured by cognis), and Lankropol 4500 (trade name for dioctyl sulfosuccinate, manufactured by Lion Akzo Co., Ltd.); alkyl polyglycoxides, such as AGNIQUE PG 8105-G (trade name, manufactured by cognis), AGNIQUE PG 264-G (trade name, manufactured by cognis), AG6202 (trade name, manufactured by Lion Akzo Co., Ltd.); and the like.

Preferable embodiments of the invention are described below.

(1) A pesticidal aqueous suspension composition comprising (a) an active ingredient compound of a sparingly water-soluble pesticide, (b) an organosilicone surface active agent, (c) a viscosity-reducing agent, (d) an antifoaming agent, (e) a pH adjustor and (f) a dispersant.
(2) The composition as set forth in (1), wherein a blend ratio of (a) the active ingredient compound of a sparingly water-soluble pesticide to (b) the organosilicone surface active agent is from 1:5,000 to 100:1 by weight.
(3) The composition as set forth in (1), wherein (a) the active ingredient compound of a sparingly water-soluble pesticide is an active ingredient compound of a sparingly water-soluble fungicide.
(4) The composition as set forth in (3), wherein the active ingredient compound of a sparingly water-soluble fungicide is at least one member selected from the group consisting of cyazofamid, fluazinam and amisulbrom.
(5) The composition as set forth in (3), wherein the active ingredient compound of a sparingly water-soluble fungicide is cyazofamid.
(6) The composition as set forth in (3), wherein the active ingredient compound of a sparingly water-soluble fungicide is fluazinam.
(7) The composition as set forth in (3), wherein the active ingredient compound of a sparingly water-soluble fungicide is amisulbrom.
(8) The composition as set forth in (1), wherein (c) the viscosity-reducing agent is a dihydric alcohol or a polyoxyethylene styrylphenyl ether anionic surface active agent.
(9) The composition as set forth in (1), wherein an active ingredient of (d) the antifoaming agent is polydimethylsiloxane.
(10) The composition as set forth in (1), wherein the composition is adjusted at a pH of from 6 to 8 by (e) the pH adjustor, thereby stabilizing (b) the organosilicone surface active agent.
(11) The composition as set forth in (8), wherein (c) the viscosity-reducing agent is propylene glycol or a potassium salt of polyoxyethylene tristyrylphenyl ether phosphoric acid ester.
(12) A method for reducing a viscosity of a pesticidal aqueous suspension composition comprising (a) an active ingredient compound of a sparingly water-soluble pesticide, (b) an organosilicone surface active agent, (d) an antifoaming agent, (e) a pH adjustor and (f) a dispersant, said method comprising using (c) a viscosity-reducing agent.
(13) A method for reducing a foaming property of a pesticidal aqueous suspension composition comprising (a) an active ingredient compound of a sparingly water-soluble pesticide, (b) an organosilicone surface active agent, (c) a viscosity-reducing agent, (e) a pH adjustor and (f) a dispersant at the time of dilution with water, said method comprising using (d) an antifoaming agent.

### EXAMPLES

Now, Examples according to the invention are described below, but it should not be construed that the invention is limited thereto.

### Example 1

| | | |
|---|---|---|
| (1) (a) Active ingredient: Cyazofamid (purity: 96.6%) | 25.0 | parts by weight |
| (2) (b) Organosilicone surface active agent: SILWET 408 (trade name, manufactured by | 9.0 | parts by weight |
| Momentive Performance Materials) | | |
| (3) (c) Viscosity-reducing agent: Potassium salt of polyoxyethylene tristyrylphenyl | 2.2 | parts by weight |
| ether phosphoric acid ester: Soprophor FLK/70 (trade name, manufactured by Rhodia | | |
| Nicca Ltd.) | | |
| (4) (c) Viscosity-reducing agent: Propylene glycol | 9.0 | parts by weight |
| (5) (d) Antifoaming agent: Rhodorsil Antifoam 432 (trade name, manufactured by | 0.9 | parts by weight |
| Rhodia Nicca Ltd.) | | |
| (6) (e) pH adjustor: 0.2 M phosphate buffer (Na₂HPO₄—NaH₂PO₄) | 51.7 | parts by weight |
| (7) (f) Dispersant: Sodium alkylnaphthalene sulfonate-formaldehyde condensate | 2.2 | parts by weight |
| (Supragil MNS/25 (trade name, manufactured by Rhodia Nicca Ltd.)) | | |

The foregoing components (1) and (3) to (7) were mixed, followed by wet pulverization until the average particle size of cyazofamid reached 0.4 μm, and the component (2) was then added thereto, followed by stirring to obtain an aqueous suspension composition.

### Example 2

| | | |
|---|---|---|
| (1) (a) Active ingredient: Cyazofamid (purity: 93.3%) | 18.9 | parts by weight |
| (2) (b) Organosilicone surface active agent: KF-644 (trade name, manufactured by Shin- | 13.4 | parts by weight |
| Etsu Chemical Co., Ltd.) | | |
| (3) (c) Viscosity-reducing agent: Propylene glycol | 17.8 | parts by weight |
| (4) (d) Antifoaming agent: Rhodorsil Antifoam 432 (trade name) | 0.1 | parts by weight |
| (5) (d) Antifoaming agent: Anti-mousse (trade name, manufactured by BELCHIM | 2.7 | parts by weight |
| CROP PROTECTION) | | |
| (6) (e) pH adjustor: 0.1 M phosphate buffer (Na₂HPO₄—NaH₂PO₄) | 43.5 | parts by weight |
| (7) (f) Dispersant: Sodium alkylnaphthalene sulfonate-formaldehyde condensate | 3.6 | parts by weight |
| (Supragil MNS/25 (trade name)) | | |

The foregoing components (1), (3), (4), (6) and (7) were mixed, followed by wet pulverization until the average particle size of cyazofamid reached 0.7 and the components (2) and (5) were then added thereto, followed by stirring to obtain an aqueous suspension composition.

### Example 3

| | | |
|---|---|---|
| (1) (a) Active ingredient: Cyazofamid (purity: 93.3%) | 17.3 | parts by weight |
| (2) (b) Organosilicone surface active agent: KF-644 (trade name) | 16.4 | parts by weight |
| (3) (c) Viscosity-reducing agent: Propylene glycol | 16.4 | parts by weight |
| (4) (d) Antifoaming agent: Rhodorsil Antifoam 432 (trade name) | 0.1 | parts by weight |
| (5) (d) Antifoaming agent: Anti-mousse (trade name) | 2.5 | parts by weight |
| (6) (e) pH adjustor: 0.1M phosphate buffer (Na₂HPO₄—NaH₂PO₄) | 44.0 | parts by weight |
| (7) (f) Dispersant: Sodium alkylnaphthalene sulfonate-formaldehyde condensate | 3.3 | parts by weight |
| (Supragil MNS/25 (trade name)) | | |

The foregoing components (1), (3), (4), (6) and (7) were mixed, followed by wet pulverization until the average particle size of cyazofamid reached 0.7 μm, and the component (2) and (5) were then added thereto, followed by stirring to obtain an aqueous suspension composition.

### Example 4

| | | |
|---|---|---|
| (1) (a) Active ingredient: Cyazofamid (purity: 93.3%) | 15.7 | parts by weight |
| (2) (b) Organosilicone surface active agent: KF-644 (trade name) | 13.9 | parts by weight |
| (3) (c) Viscosity-reducing agent: Potassium salt of polyoxyethylene tristyrylphenyl | 1.9 | parts by weight |
| ether phosphoric acid ester (Soprophor FLK/70 (trade name)) | | |
| (4) (c) Viscosity-reducing agent: Propylene glycol | 9.3 | parts by weight |
| (5) (d) Antifoaming agent: Anti-mousse (trade name) | 4.6 | parts by weight |
| (6) (e) pH adjustor: 0.1M phosphate buffer (Na₂HPO₄—NaH₂PO₄) | 52.7 | parts by weight |
| (7) (f) Dispersant: Sodium alkylnaphthalene sulfonate-formaldehyde condensate | 1.9 | parts by weight |
| (Supragil MNS/25 (trade name)) | | |

The foregoing components (1), (3), (4), (6) and (7) were mixed, followed by wet pulverization until the average particle size of cyazofamid reached 0.7 μm, and the component (2) and (5) were then added thereto, followed by stirring to obtain an aqueous suspension composition.

### Example 5

| | | |
|---|---|---|
| (1) (a) Active ingredient: Cyazofamid (purity: 93.3%) | 15.7 | parts by weight |
| (2) (b) Organosilicone surface active agent: KF-644 (trade name) | 13.9 | parts by weight |
| (3) (c) Viscosity-reducing agent: Potassium salt of polyoxyethylene tristyrylphenyl | 1.9 | parts by weight |
| ether phosphoric acid ester (Soprophor FLK/70 (trade name)) | | |
| (4) (c) Viscosity-reducing agent: Propylene glycol | 9.3 | parts by weight |
| (5) (d) Antifoaming agent: Rhodorsil Antifoam 432 (trade name) | 0.9 | parts by weight |
| (6) (e) pH adjustor: 0.1M phosphate buffer (Na₂HPO₄—NaH₂PO₄) | 56.4 | parts by weight |
| (7) (f) Dispersant: Sodium alkylnaphthalene sulfonate-formaldehyde condensate | 1.9 | parts by weight |
| (Supragil MNS/25 (trade name)) | | |

The foregoing components (1) and (3) to (7) were mixed, followed by wet pulverization until the average particle size of cyazofamid reached 0.7 μm, and the component (2) was then added thereto, followed by stirring to obtain an aqueous suspension composition.

### Example 6

| | | |
|---|---|---|
| (1) (a) Active ingredient: Cyazofamid (purity: 93.3%) | 15.7 | parts by weight |
| (2) (b) Organosilicone surface active agent: SILWET L-77 (trade name, manufactured | 9.3 | parts by weight |
| by Momentive Performance Materials) | | |
| (3) (c) Viscosity-reducing agent: Potassium salt of polyoxyethylene tristyrylphenyl | 1.9 | parts by weight |
| ether phosphoric acid ester (Soprophor FLK/70 (trade name)) | | |
| (4) (c) Viscosity-reducing agent: Propylene glycol | 9.3 | parts by weight |
| (5) (d) Antifoaming agent: Anti-mousse (trade name) | 2.8 | parts by weight |
| (6) (e) pH adjustor: 0.1M phosphate buffer (Na₂HPO₄—NaH₂PO₄) | 59.1 | parts by weight |
| (7) (f) Dispersant: Sodium alkylnaphthalene sulfonate-formaldehyde condensate | 1.9 | parts by weight |
| (Supragil MNS/25 (trade name)) | | |

The foregoing components (1), (3), (4), (6) and (7) were mixed, followed by wet pulverization until the average particle size of cyazofamid reached 0.7 μm, and the component (2) and (5) were then added thereto, followed by stirring to obtain an aqueous suspension composition.

### Example 7

| | | |
|---|---|---|
| (1) (a) Active ingredient: Cyazofamid (purity: 96.6%) | 36.3 | parts by weight |
| (2) (b) Organosilicone surface active agent: SILWET 408 (trade name) | 4.3 | parts by weight |
| (3) (c) Viscosity-reducing agent: Potassium salt of polyoxyethylene tristyrylphenyl | 2.2 | parts by weight |
| ether phosphoric acid ester (Soprophor FLK/70 (trade name)) | | |
| (4) (c) Viscosity-reducing agent: Propylene glycol | 15.1 | parts by weight |
| (5) (d) Antifoaming agent: Rhodorsil Antifoam 432 (trade name) | 0.4 | parts by weight |
| (6) (e) pH adjustor: 0.2M phosphate buffer (Na₂HPO₄—NaH₂PO₄) | 36.9 | parts by weight |
| (7) (f) Dispersant: Sodium alkylnaphthalene sulfonate-formaldehyde condensate | 2.2 | parts by weight |
| (Supragil MNS/90 (trade name, manufactured by Rhodia Nicca Ltd.)) | | |
| (8) Activity-enhancing component: Sodium dioctyl sulfosuccinate (NK EP-70G (trade | 2.6 | parts by weight |
| name, manufactured by Takemoto Oil and Fat Co., Ltd.)) | | |

The foregoing components. (1) and (3) to (7) were mixed, followed by wet pulverization until the average particle size of cyazofamid reached 0.5 μm, and the component (2) and (8) were then added thereto, followed by stirring to obtain an aqueous suspension composition.

### Comparative Example 1

| | | |
|---|---|---|
| (1) (a) Active ingredient: Cyazofamid (purity: 97.3%) | 24.8 | parts by weight |
| (2) (b) Organosilicone surface active agent: KF-644 (trade name) | 9.0 | parts by weight |
| (3) (c) Viscosity-reducing agent: Propylene glycol | 9.0 | parts by weight |
| (4) (d) Antifoaming agent: Rhodorsil Antifoam 432 (trade name) | 0.9 | parts by weight |
| (5) (e) pH adjustor: 0.2M phosphate buffer (Na₂HPO₄—NaH₂PO₄) | 52.7 | parts by weight |
| (6) (f) Dispersant: Sodium alkylnaphthalene sulfonate-formaldehyde condensate | 3.6 | parts by weight |
| (Supragil MNS/25 (trade name)) | | |

The foregoing components (1), (3), (5) and (6) and 0.1 parts by weight of the component (4) were mixed, followed by wet pulverization until the average particle size of cyazofamid reached 0.5 μm, and the component (2) and residual 0.8 parts by weight of the component (4) were then added thereto, followed by stirring to obtain an aqueous suspension composition.

### Comparative Example 2

| | | |
|---|---|---|
| (1) (a) Active ingredient: Cyazofamid (purity: 93.3%) | 18.9 | parts by weight |
| (2) (b) Organosilicone surface active agent: KF-644 (trade name, manufactured by Shin- | 13.4 | parts by weight |
| Etsu Chemical Co., Ltd.) | | |
| (3) (d) Antifoaming agent: Rhodorsil Antifoam 432 (trade name) | 0.1 | parts by weight |
| (4) (d) Antifoaming agent: Anti-mousse (trade name) | 2.7 | parts by weight |
| (5) (e) pH adjustor: 0.1M phosphate buffer (Na₂HPO₄—NaH₂PO₄) | 61.3 | parts by weight |
| (6) (f) Dispersant: Sodium alkylnaphthalene sulfonate-formaldehyde condensate | 3.6 | parts by weight |
| (Supragil MNS/25 (trade name)) | | |

The foregoing components (1), (3) (5) and (6) were mixed, followed by wet pulverization until the average particle size of Cyazofamid reached 0.7 μm, and the component (2) and (4) were then added thereto, followed by stirring to obtain an aqueous suspension composition.

### Comparative Example 3

| | | |
|---|---|---|
| (1) (a) Active ingredient: Cyazofamid (purity: 93.3%) | 17.3 | parts by weight |
| (2) (b) Organosilicone surface active agent: KF-644 (trade name) | 16.4 | parts by weight |
| (3) (d) Antifoaming agent: Rhodorsil Antifoam 432 (trade name) | 0.1 | parts by weight |
| (4) (d) Antifoaming agent: Anti-mousse (trade name) | 2.5 | parts by weight |
| (5) (e) pH adjustor: 0.1M phosphate buffer (Na₂HPO₄—NaH₂PO₄) | 60.4 | parts by weight |
| (6) (f) Dispersant: Sodium alkylnaphthalene sulfonate-formaldehyde condensate | 3.3 | parts by weight |
| (Supragil MNS/25 (trade name)) | | |

The foregoing components (1), (3) (5) and (6) were mixed, followed by wet pulverization until the average particle size of Cyazofamid reached 0.7 μm, and the component (2) and (4) were then added thereto, followed by stirring to obtain an aqueous suspension composition.

### Comparative Example 4

| | | |
|---|---|---|
| (1) (a) Active ingredient: Cyazofamid (purity: 93.3%) | 15.7 | parts by weight |
| (2) (b) Organosilicone surface active agent: KF-644 (trade name) | 13.9 | parts by weight |
| (3) (c) Viscosity-reducing agent: Potassium salt of polyoxyethylene tristyrylphenyl | 1.9 | parts by weight |
| ether phosphoric acid ester (Soprophor FLK/70 (trade name)) | | |
| (4) (c) Viscosity-reducing agent: Propylene glycol | 9.3 | parts by weight |
| (5) (e) pH adjustor: 0.1M phosphate buffer (Na₂HPO₄—NaH₂PO₄) | 57.3 | parts by weight |
| (6) (f) Dispersant: Sodium alkylnaphthalene sulfonate-formaldehyde condensate | 1.9 | parts by weight |
| (Supragil MNS/25 (trade name)) | | |

The foregoing components (1) and (3) to (6) were mixed, followed by wet pulverization until the average particle size of Cyazofamid reached 0.7 μm, and the component (2) was then added thereto, followed by stirring to obtain an aqueous suspension composition.

### Comparative Example 5

| | | |
|---|---|---|
| (1) (a) Active ingredient: Cyazofamid (purity: 93.3%) | 15.7 | parts by weight |
| (2) (b) Organosilicone surface active agent: SILWET L-77 (trade name) | 9.3 | parts by weight |
| (3) (c) Viscosity-reducing agent: Potassium salt of polyoxyethylene tristyrylphenyl | 1.9 | parts by weight |
| ether phosphoric acid ester (Soprophor FLK/70 (trade name)) | | |
| (4) (c) Viscosity-reducing agent: Propylene glycol | 9.3 | parts by weight |
| (5) (e) pH adjustor: 0.1M phosphate buffer (Na₂HPO₄—NaH₂PO₄) | 61.9 | parts by weight |
| (6) (f) Dispersant: Sodium alkylnaphthalene sulfonate-formaldehyde condensate | 1.9 | parts by weight |
| (Supragil MNS/25 (trade name)) | | |

The foregoing components (1) and (3) to (6) were mixed, followed by wet pulverization until the average particle size of Cyazofamid reached 0.7 μm, and the component (2) was then added thereto, followed by stirring to obtain an aqueous suspension composition.

### Comparative Example 6

| | | |
|---|---|---|
| (1) (a) Active ingredient: Cyazofamid (purity: 96.6%) | 36.3 | parts by weight |
| (2) (b) Organosilicone surface active agent: SILWET 408 (trade name) | 4.3 | parts by weight |
| (3) (c) Viscosity-reducing agent: Propylene glycol | 15.1 | parts by weight |
| (4) (d) Antifoaming agent: Rhodorsil Antifoam 432 (trade name) | 0.4 | parts by weight |
| (5) (e) pH adjustor: 0.2M phosphate buffer (Na₂HPO₄—NaH₂PO₄) | 37.9 | parts by weight |
| (6) (f) Dispersant: Sodium alkylnaphthalene sulfonate-formaldehyde condensate | 3.4 | parts by weight |
| (Supragil MNS/90 (trade name, manufactured by Rhodia Nicca Ltd.)) | | |
| (7) Activity-enhancing component Sodium dioctyl sulfosuccinate (NK EP-70G (trade | 2.6 | parts by weight |
| name)) | | |

The foregoing components (1) and (3) to (6) were mixed, followed by wet pulverization until the average particle size of Cyazofamid reached 0.8 μm, and the component (2) and (7) were then added thereto, followed by stirring to obtain an aqueous suspension composition.

### Test Example 1

### Viscosity Test

### (1) Test Method:

Each of the aqueous suspension compositions obtained in the foregoing Examples 1 to 3 and 7 and Comparative Examples 1 to 3 and 6 was filled in a 30-mL glass-made bottle, and after capping, the glass-made bottle was soaked in a constant temperature water bath at 20° C. Thirty minutes later, the glass-made bottle was taken out, and the viscosity of the aqueous suspension composition was measured using a B-type viscometer. The results are shown in Table 1.

### (2) Viscosity Measurement Condition:

Rotor: No. 3

rotation number of rotor: 60 rpm

Rotation time of rotor: 60 seconds

TABLE 1

| Kinds of | | | Comp. | | Comp. | | Comp. | | Comp. |
|---|---|---|---|---|---|---|---|---|---|
| Ingredient | Ingredient | Ex. 1 | Ex. 1 | Ex. 2 | Ex. 2 | Ex. 3 | Ex. 3 | Ex. 7 | Ex. 6 |
| (a) | cyazofamid | 25.0 | 24.8 | 18.9 | 18.9 | 17.3 | 17.3 | 36.3 | 36.3 |
| (b) | SILWET 408 | 9.0 | — | — | — | — | — | 4.3 | 4.3 |
| (b) | KF-644 | — | 9.0 | 13.4 | 13.4 | 16.4 | 16.4 | — | — |
| (b) | SILWET L-77 | — | — | — | — | — | — | — | — |
| (c) | Soprophor FLK/70 | 2.2 | — | — | — | — | — | 2.2 | — |
| (c) | Propylene glycol | 9.0 | 9.0 | 17.8 | — | 16.4 | — | 15.1 | 15.1 |
| (d) | Rhodorsil | 0.9 | 0.9 | 0.1 | 0.1 | 0.1 | 0.1 | 0.4 | 0.4 |
| | Antifoam 432 | | | | | | | | |
| (d) | Anti-mousse | — | — | 2.7 | 2.7 | 2.5 | 2.5 | — | — |
| (e) | 0.2M phosphate buffer | 51.7 | 52.7 | — | — | — | — | 36.9 | 37.9 |
| (e) | 0.1M phosphate buffer | — | — | 43.5 | 61.3 | 44.0 | 60.4 | — | — |
| (f) | Supragil MNS/25 | 2.2 | 3.6 | 3.6 | 3.6 | 3.3 | 3.3 | — | — |
| (f) | Supragil MNS/90 | — | — | — | — | — | — | 2.2 | 3.4 |
| Activity- | New Kalgen | — | — | — | — | — | — | 2.6 | 2.6 |
| enhancing | EP-70G | | | | | | | | |
| component | | | | | | | | | |
| | Viscosity | 344 | 590 | 219 | 419 | 273 | 350 | 610 | 1030 |
| | (mPa · S) | | | | | | | | |

It is understood from the results shown in Table 1 that when propylene glycol is used as a dihydric alcohol which is the viscosity-reducing agent in the present invention, the increase in the viscosity of the aqueous suspension composition is suppressed. In addition, it is understood from the results shown in Table 1 that when a potassium salt of polyoxyethylene tristyrylphenyl ether phosphoric acid ester is used as a polyoxyethylene styrylphenyl ether anionic surface active agent which is the viscosity-reducing agent in the present invention, the increase in the viscosity of the aqueous suspension composition is suppressed, too.

### Test Example 2

### Foaming Property Test Example

An aqueous dispersion of each of the aqueous suspension compositions of Examples 4 to 6 and Comparative Examples 4 to 5 was prepared so as to have a concentration of the organosilicone surface active agent of 500 ppm. In a measuring cylinder with ground stopper having a volume of 250 mL, 10 mL of the aqueous dispersion was charged, and 100 mL of water was added, followed by putting the stopper in the measuring cylinder. Thereafter, the measuring cylinder was overturned 30 times for one minute and then allowed to stand. One minute later, the volume of foams was measured. The results are shown in Table 2.

TABLE 2

| Kinds of | | | | Comp. | | Comp. |
|---|---|---|---|---|---|---|
| Ingredient | Ingredient | Ex. 4 | Ex. 5 | Ex. 4 | Ex. 6 | Ex. 5 |
| (a) | cyazofamid | 15.7 | 15.7 | 15.7 | 15.7 | 15.7 |
| (b) | KF-644 | 13.9 | 13.9 | 13.9 | — | — |
| (b) | SILWET L-77 | — | — | — | 9.3 | 9.3 |
| (c) | Soprophor FLK/70 | 1.9 | 1.9 | 1.9 | 1.9 | 1.9 |
| (c) | Propylene glycol | 9.3 | 9.3 | 9.3 | 9.3 | 9.3 |
| (d) | Rhodorsil Antifoam | — | 0.9 | — | — | — |
| | 432 | | | | | |
| (d) | Anti-mousse | 4.6 | — | — | 2.8 | |
| (e) | 0.1M phosphate | 52.7 | 56.4 | 57.3 | 59.1 | 61.9 |
| | buffer | | | | | |
| (f) | Supragil MNS/25 | 1.9 | 1.9 | 1.9 | 1.9 | 1.9 |
| (f) | Supragil MNS/90 | — | — | — | — | — |
| | Volume of | 16 | 26 | 50 | 13 | 38 |
| | foam (mL) | | | | | |

It is understood from the results shown in Table 2 that when the silicone antifoaming agent in the present invention is used, the foaming property of the aqueous dispersion of the aqueous suspension composition is remarkably suppressed.

Next, examples of the composition of the present invention in some formulations except for the above Examples are described below as Formulation Examples, but the present invention should not be construed that the invention is limited to Examples or Formulation Examples including blend weight ratio, formulation and the like.

### Formulation Example 1

| | | |
|---|---|---|
| (1) (a) Active ingredient: Fluazinam (purity: 97.7%) | 25.0 | parts by weight |
| (2) (b) Organosilicone surface active agent: SILWET 408 (trade name, manufactured by | 9.0 | parts by weight |
| Momentive Performance Materials) | | |
| (3) (c) Viscosity-reducing agent: Potassium salt of polyoxyethylene tristyrylphenyl | 2.2 | parts by weight |
| ether phosphoric acid ester (Soprophor FLK/70 (trade name, manufactured by Rhodia | | |
| Nicca Ltd.)) | | |
| (4) (c) Viscosity-reducing agent: Propylene glycol | 9.0 | parts by weight |
| (5) (d) Antifoaming agent: Rhodorsil Antifoam 432 (trade name, manufactured by | 0.9 | parts by weight |
| Rhodia Nicca Ltd.)) | | |
| (6) (e) pH adjustor: 0.2M phosphate buffer (Na₂HPO₄—NaH₂PO₄) | 51.7 | parts by weight |
| (7) (f) Dispersant: Sodium alkylnaphthalene sulfonate-formaldehyde condensate | 2.2 | parts by weight |
| (Supragil MNS/25 (trade name, manufactured by Rhodia Nicca Ltd.)) | | |

The foregoing components (1) and (3) to (7) are mixed, followed by wet pulverization until the average particle size of fluazinam reached 1.0 μm, and the component (2) is then added thereto, followed by stirring to obtain an aqueous suspension composition.

### Formulation Example 2

| | | |
|---|---|---|
| (1) (a) Active ingredient: Fluazinam (purity: 97.7%) | 18.9 | parts by weight |
| (2) (b) Organosilicone surface active agent: KF-644 (trade name, manufactured by Shin- | 13.4 | parts by weight |
| Etsu Chemical Co., Ltd.) | | |
| (3) (c) Viscosity-reducing agent: Propylene glycol | 17.8 | parts by weight |
| (4) (d) Antifoaming agent: Rhodorsil Antifoam 432 (trade name) | 0.1 | parts by weight |
| (5) (d) Antifoaming agent: Anti-mousse (trade name, manufactured by BELCHIM | 2.7 | parts by weight |
| CROP PROTECTION) | | |
| (6) (e) pH adjustor: 0.1M phosphate buffer (Na₂HPO₄—NaH₂PO₄) | 43.5 | parts by weight |
| (7) (f) Dispersant: Sodium alkylnaphthalene sulfonate-formaldehyde condensate | 3.6 | parts by weight |
| (Supragil MNS/25 (trade name)) | | |

The foregoing components (1), (3) (4), (6) and (7) are mixed, followed by wet pulverization until the average particle size of fluazinam reached 0.7 μm, and the component (2) and (5) are then added thereto, followed by stirring to obtain an aqueous suspension composition.

### Formulation Example 3

| | | |
|---|---|---|
| (1) (a) Active ingredient: Fluazinam (purity: 97.7%) | 17.3 | parts by weight |
| (2) (b) Organosilicone surface active agent: KF-644 (trade name) | 16.4 | parts by weight |
| (3) (c) Viscosity-reducing agent: Propylene glycol | 16.4 | parts by weight |
| (4) (d) Antifoaming agent: Rhodorsil Antifoam 432 (trade name) | 0.1 | parts by weight |
| (5) (d) Antifoaming agent: Anti-mousse (trade name) | 2.5 | parts by weight |
| (6) (e) pH adjustor: 0.1M phosphate buffer (Na₂HPO₄—NaH₂PO₄) | 44.0 | parts by weight |
| (7) (f) Dispersant: Sodium alkylnaphthalene sulfonate-formaldehyde condensate | 3.3 | parts by weight |
| (Supragil MNS/25 (trade name)) | | |

The foregoing components (1), (3) (4), (6) and (7) are mixed, followed by wet pulverization until the average particle size of fluazinam reached 0.7 μm, and the component (2) and (5) are then added thereto, followed by stirring to obtain an aqueous suspension composition.

### Formulation Example 4

| | | |
|---|---|---|
| (1) (a) Active ingredient: Fluazinam | 15.7 | parts by weight |
| (2) (b) Organosilicone surface active agent: KF-644 (trade name) | 13.9 | parts by weight |
| (3) (c) Viscosity-reducing agent: Potassium salt of polyoxyethylene tristyrylphenyl | 1.9 | parts by weight |
| ether phosphoric acid ester (Soprophor FLK/70 (trade name)) | | |
| (4) (c) Viscosity-reducing agent: Propylene glycol | 9.3 | parts by weight |
| (5) (d) Antifoaming agent: Anti-mousse (trade name) | 4.6 | parts by weight |
| (6) (e) pH adjustor: 0.1M phosphate buffer (Na₂HPO₄—NaH₂PO₄) | 52.7 | parts by weight |
| (7) (f) Dispersant: Sodium alkylnaphthalene sulfonate-formaldehyde condensate | 1.9 | parts by weight |
| (Supragil MNS/25 (trade name)) | | |

The foregoing components (1), (3) (4), (6) and (7) are mixed, followed by wet pulverization until the average particle size of fluazinam reached 0.7 μm, and the component (2) and (5) are then added thereto, followed by stirring to obtain an aqueous suspension composition.

### Formulation Example 5

| | | |
|---|---|---|
| (1) (a) Active ingredient: Fluazinam (purity: 97.7%) | 15.7 | parts by weight |
| (2) (b) Organosilicone surface active agent: KF-644 (trade name) | 13.9 | parts by weight |
| (3) (c) Viscosity-reducing agent: Potassium salt of polyoxyethylene tristyrylphenyl | 1.9 | parts by weight |
| ether phosphoric acid ester (Soprophor FLK/70 (trade name)) | | |
| (4) (c) Viscosity-reducing agent: Propylene glycol | 9.3 | parts by weight |
| (5) (d) Antifoaming agent: Rhodorsil Antifoam 432 (trade name) | 0.9 | parts by weight |
| (6) (e) pH adjustor: 0.1M phosphate buffer (Na₂HPO₄—NaH₂PO₄) | 56.4 | parts by weight |
| (7) (f) Dispersant: Sodium alkylnaphthalene sulfonate-formaldehyde condensate | 1.9 | parts by weight |
| (Supragil MNS/25 (trade name)) | | |

The foregoing components (1) and (3) to (7) are mixed, followed by wet pulverization until the average particle size of fluazinam reached 0.7 μm, and the component (2) is then added thereto, followed by stirring to obtain an aqueous suspension composition.

### Formulation Example 6

| | | |
|---|---|---|
| (1) (a) Active ingredient: Fluazinamm (purity: 97.7%) | 15.7 | parts by weight |
| (2) (b) Organosilicone surface active agent: SILWET L-77 (trade name, manufactured | 9.3 | parts by weight |
| by Momentive Performance Materials) | | |
| (3) (c) Viscosity-reducing agent: Potassium salt of polyoxyethylene tristyrylphenyl | 1.9 | parts by weight |
| ether phosphoric acid ester (Soprophor FLK/70 (trade name)) | | |
| (4) (c) Viscosity-reducing agent: Propylene glycol | 9.3 | parts by weight |
| (5) (d) Antifoaming agent: Anti-mousse (trade name) | 2.8 | parts by weight |
| (6) (e) pH adjustor: 0.1M phosphate buffer (Na₂HPO₄—NaH₂PO₄) | 59.1 | parts by weight |
| (7) (f) Dispersant: Sodium alkylnaphthalene sulfonate-formaldehyde condensate | 1.9 | parts by weight |
| (Supragil MNS/25 (trade name)) | | |

The foregoing components (1), (3) (4), (6) and (7) are mixed, followed by wet pulverization until the average particle size of fluazinam reached 0.7 μm, and the component (2) and (5) are then added thereto, followed by stirring to obtain an aqueous suspension composition.

### Formulation Example 7

| | | |
|---|---|---|
| (1) (a) Active ingredient: Fluazinamm (purity: 97.7%) | 36.3 | parts by weight |
| (2) (b) Organosilicone surface active agent: SILWET 408 (trade name) | 4.3 | parts by weight |
| (3) (c) Viscosity-reducing agent: Potassium salt of polyoxyethylene tristyrylphenyl | 2.2 | parts by weight |
| ether phosphoric acid ester (Soprophor FLK/70 (trade name)) | | |
| (4) (c) Viscosity-reducing agent: Propylene glycol | 15.1 | parts by weight |
| (5) (d) Antifoaming agent: Rhodorsil Antifoam 432 (trade name) | 0.4 | parts by weight |
| (6) (e) pH adjustor: 0.2M phosphate buffer (Na₂HPO₄—NaH₂PO₄) | 36.9 | parts by weight |
| (7) (f) Dispersant: Sodium alkylnaphthalene sulfonate-formaldehyde condensate | 2.2 | parts by weight |
| (Supragil MNS/90 (trade name, manufactured by Rhodia Nicca Ltd.)) | | |
| (8) Activity-enhancing component: Sodium dioctyl sulfosuccinate (NK EP-70G (trade | 2.6 | parts by weight |
| name, manufactured by Takemoto Oil and Fat Co., Ltd.)) | | |

The foregoing components (1) and (3) to (7) are mixed, followed by wet pulverization until the average particle size of fluazinam reached 1.0 μm, and the component (2) and (8) are then added thereto, followed by stirring to obtain an aqueous suspension composition.

### Formulation Example 8

| | | |
|---|---|---|
| (1) (a) Active ingredient: amisulbrom | 25.0 | parts by weight |
| (2) (b) Organosilicone surface active agent: SILWET 408 (trade name, manufactured by | 9.0 | parts by weight |
| Momentive Performance Materials) | | |
| (3) (c) Viscosity-reducing agent: Potassium salt of polyoxyethylene tristyrylphenyl | 2.2 | parts by weight |
| ether phosphoric acid ester (Soprophor FLK/70 (trade name, manufactured by Rhodia | | |
| Nicca Ltd.)) | | |
| (4) (c) Viscosity-reducing agent: Propylene glycol | 9.0 | parts by weight |
| (5) (d) Antifoaming agent: Rhodorsil Antifoam 432 (trade name, manufactured by | 0.9 | parts by weight |
| Rhodia Nicca Ltd.) | | |
| (6) (e) pH adjustor: 0.2M phosphate buffer (Na₂HPO₄—NaH₂PO₄) | 51.7 | parts by weight |
| (7) (f) Dispersant: Sodium alkylnaphthalene sulfonate-formaldehyde condensate | 2.2 | parts by weight |
| (Supragil MNS/25 (trade name, manufactured by Rhodia Nicca Ltd.)) | | |

The foregoing components (1) and (3) to (7) are mixed, followed by wet pulverization until the average particle size of amisulbrom reached 0.4 μm, and the component (2) is then added thereto, followed by stirring to obtain an aqueous suspension composition.

### Formulation Example 9

| | | |
|---|---|---|
| (1) (a) Active ingredient: Amisulbrom | 18.9 | parts by weight |
| (2) (b) Organosilicone surface active agent: KF-644 (trade name, manufactured by Shin- | 13.4 | parts by weight |
| Etsu Chemical Co., Ltd.) | | |
| (3) (c) Viscosity-reducing agent: Propylene glycol | 17.8 | parts by weight |
| (4) (d) Antifoaming agent: Rhodorsil Antifoam 432 (trade name) | 0.1 | parts by weight |
| (5) (d) Antifoaming agent: Anti-mousse (trade name, manufactured by BELCHIM | 2.7 | parts by weight |
| CROP PROTECTION) | | |
| (6) (e) pH adjustor: 0.1M phosphate buffer (Na₂HPO₄—NaH₂PO₄) | 43.5 | parts by weight |
| (7) (f) Dispersant: Sodium alkylnaphthalene sulfonate-formaldehyde condensate | 3.6 | parts by weight |
| (Supragil MNS/25 (trade name)) | | |

The foregoing components (1), (3) (4), (6) and (7) are mixed, followed by wet pulverization until the average particle size of amisulbrom reached 0.7 μm, and the component (2) and (5) are then added thereto, followed by stirring to obtain an aqueous suspension composition.

### Formulation Example 10

| | | |
|---|---|---|
| (1) (a) Active ingredient: Amisulbrom | 17.3 | parts by weight |
| (2) (b) Organosilicone surface active agent: KF-644 (trade name) | 16.4 | parts by weight |
| (3) (c) Viscosity-reducing agent: Propylene glycol | 16.4 | parts by weight |
| (4) (d) Antifoaming agent: Rhodorsil Antifoam 432 (trade name) | 0.1 | parts by weight |
| (5) (d) Antifoaming agent: Anti-mousse (trade name) | 2.5 | parts by weight |
| (6) (e) pH adjustor: 0.1M phosphate buffer (Na₂HPO₄—NaH₂PO₄) | 44.0 | parts by weight |
| (7) (f) Dispersant: Sodium alkylnaphthalene sulfonate-formaldehyde condensate | 3.3 | parts by weight |
| (Supragil MNS/25 (trade name)) | | |

The foregoing components (1), (3) (4), (6) and (7) are mixed, followed by wet pulverization until the average particle size of amisulbrom reached 0.7 μm, and the component (2) and (5) are then added thereto, followed by stirring to obtain an aqueous suspension composition.

### Formulation Example 11

| | | |
|---|---|---|
| (1) (a) Active ingredient: Amisulbrom | 15.7 | parts by weight |
| (2) (b) Organosilicone surface active agent: KF-644 (trade name) | 13.9 | parts by weight |
| (3) (c) Viscosity-reducing agent: Potassium salt of polyoxyethylene tristyrylphenyl | 1.9 | parts by weight |
| ether phosphoric acid ester (Soprophor FLK/70 (trade name)) | | |
| (4) (c) Viscosity-reducing agent: Propylene glycol | 9.3 | parts by weight |
| (5) (d) Antifoaming agent: Anti-mousse (trade name) | 4.6 | parts by weight |
| (6) (e) pH adjustor: 0.1M phosphate buffer (Na₂HPO₄—NaH₂PO₄) | 52.7 | parts by weight |
| (7) (f) Dispersant: Sodium alkylnaphthalene sulfonate-formaldehyde condensate | 1.9 | parts by weight |
| (Supragil MNS/25 (trade name)) | | |

The foregoing components (1), (3) (4), (6) and (7) are mixed, followed by wet pulverization until the average particle size of amisulbrom reached 0.7 μm, and the component (2) and (5) are then added thereto, followed by stirring to obtain an aqueous suspension composition.

### Formulation Example 12

| | | |
|---|---|---|
| (1) (a) Active ingredient: amisulbrom | 15.7 | parts by weight |
| (2) (b) Organosilicone surface active agent: KF-644 (trade name) | 13.9 | parts by weight |
| (3) (c) Viscosity-reducing agent: Potassium salt of polyoxyethylene tristyrylphenyl | 1.9 | parts by weight |
| ether phosphoric acid ester (Soprophor FLK/70 (trade name)) | | |
| (4) (c) Viscosity-reducing agent: Propylene glycol | 9.3 | parts by weight |
| (5) (d) Antifoaming agent: Rhodorsil Antifoam 432 (trade name) | 0.9 | parts by weight |
| (6) (e) pH adjustor: 0.1M phosphate buffer (Na₂HPO₄—NaH₂PO₄) | 56.4 | parts by weight |
| (7) (f) Dispersant: Sodium alkylnaphthalene sulfonate-formaldehyde condensate | 1.9 | parts by weight |
| (Supragil MNS/25 (trade name)) | | |

The foregoing components (1) and (3) to (7) are mixed, followed by wet pulverization until the average particle size of amisulbrom reached 0.7 μm, and the component (2) is then added thereto, followed by stirring to obtain an aqueous suspension composition.

### Formulation Example 13

| | | |
|---|---|---|
| (1) (a) Active ingredient: amisulbrom | 15.7 | parts by weight |
| (2) (b) Organosilicone surface active agent: SILWET L-77 (trade name, manufactured | 9.3 | parts by weight |
| by Momentive Performance Materials) | | |
| (3) (c) Viscosity-reducing agent: Potassium salt of polyoxyethylene tristyrylphenyl | 1.9 | parts by weight |
| ether phosphoric acid ester (Soprophor FLK/70 (trade name)) | | |
| (4) (c) Viscosity-reducing agent: Propylene glycol | 9.3 | parts by weight |
| (5) (d) Antifoaming agent: Anti-mousse (trade name) | 2.8 | parts by weight |
| (6) (e) pH adjustor: 0.1M phosphate buffer (Na₂HPO₄—NaH₂PO₄) | 59.1 | parts by weight |
| (7) (f) Dispersant: Sodium alkylnaphthalene sulfonate-formaldehyde condensate | 1.9 | parts by weight |
| (Supragil MNS/25 (trade name)) | | |

The foregoing components (1), (3) (4), (6) and (7) are mixed, followed by wet pulverization until the average particle size of amisulbrom reached 0.7 μm, and the component (2) and (5) are then added thereto, followed by stirring to obtain an aqueous suspension composition.

### Formulation Example 14

| | | |
|---|---|---|
| (1) (a) Active ingredient: amisulbrom | 36.3 | parts by weight |
| (2) (b) Organosilicone surface active agent: SILWET 408 (trade name) | 4.3 | parts by weight |
| (3) (c) Viscosity-reducing agent: Potassium salt of polyoxyethylene tristyrylphenyl | 2.2 | parts by weight |
| ether phosphoric acid ester (Soprophor FLK/70 (trade name)) | | |
| (4) (c) Viscosity-reducing agent: Propylene glycol | 15.1 | parts by weight |
| (5) (d) Antifoaming agent: Rhodorsil Antifoam 432 (trade name) | 0.4 | parts by weight |
| (6) (e) pH adjustor: 0.2M phosphate buffer (Na₂HPO₄—NaH₂PO₄) | 36.9 | parts by weight |
| (7) (f) Dispersant: Sodium alkylnaphthalene sulfonate-formaldehyde condensate | 2.2 | parts by weight |
| (Supragil MNS/90 (trade name, manufactured by Rhodia Nicca Ltd.)) | | |
| (8) Activity-enhancing component: Sodium dioctyl sulfosuccinate (NK EP-70G (trade | 2.6 | parts by weight |
| name, manufactured by Takemoto Oil and Fat Co., Ltd.)) | | |

The foregoing components (1), (3) to (7) are mixed, followed by wet pulverization until the average particle size of amisulbrom reached 0.5 μm, and the component (2) and (8) are then added thereto, followed by stirring to obtain an aqueous suspension composition.

While the invention has been described in detail and with reference to specific embodiments thereof, it will be apparent to one skill in the art that various changes and modifications can be made therein without departing from the spirit and scope thereof. This application is based on Japanese patent application No. 2008-090141 filed on Mar. 31, 2008, the entire contents of which are incorporated hereinto by reference. All references cited herein are incorporated in their entirety.

### INDUSTRIAL APPLICABILITY

The present invention provides a pesticidal aqueous suspension composition which is suppressed in increasing in the viscosity, is easy to measure, hardly generates foams at the time of dilution with water and is easy to prepare a spray solution.

1. A pesticidal aqueous suspension composition comprising (a) an active ingredient compound of a sparingly water-soluble pesticide, (b) an organosilicone surface active agent, (c) a viscosity-reducing agent, (d) an antifoaming agent, (e) a pH adjustor and (f) a dispersant.

2. The composition according to claim 1, wherein a blend ratio of (a) the active ingredient compound of a sparingly water-soluble pesticide to (b) the organosilicone surface active agent is from 1:5,000 to 100:1 by weight.

3. The composition according to claim 1, wherein (a) the active ingredient compound of a sparingly water-soluble pesticide is an active ingredient compound of a sparingly water-soluble fungicide.

4. The composition according to claim 3, wherein the active ingredient compound of a sparingly water-soluble fungicide is cyazofamid.

5. The composition according to claim 1, wherein (c) the viscosity-reducing agent is dihydric alcohol or a polyoxyethylene styrylphenyl ether anionic surface active agent.

6. The composition according to claim 1, wherein an active ingredient of (d) the antifoaming agent is polydimethylsiloxane.

7. The composition according to claim 1, wherein the composition is adjusted at a pH of from 6 to 8 by (e) the pH adjustor, thereby stabilizing (b) the organosilicone surface active agent.

8. The composition according to claim 5, wherein (c) the viscosity-reducing agent is propylene glycol or a potassium salt of polyoxyethylene tristyrylphenyl ether phosphoric acid ester.

9. A method for reducing a viscosity of a pesticidal aqueous suspension composition comprising (a) an active ingredient compound of a sparingly water-soluble pesticide, (b) an organosilicone surface active agent, (d) an antifoaming agent, (e) a pH adjustor and (f) a dispersant, said method comprising using (c) a viscosity-reducing agent.

10. A method for reducing a foaming property of a pesticidal aqueous suspension composition comprising (a) an active ingredient compound of a sparingly water-soluble pesticide, (b) an organosilicone surface active agent, (c) a viscosity-reducing agent, (e) a pH adjustor and (f) a dispersant at the time of dilution with water, said method comprising using (d) an antifoaming agent.
